(19) United States
(12) Patent Application Publication
(10) Pub. No.: US 2020/0325060 A1
(43) Pub. Date: Oct. 15, 2020

(54) METHOD FOR PRODUCING GLASS PLATE

(71) Applicant: Nippon Electric Glass Co., Ltd., Shiga (JP)

(72) Inventors: Toru SAKURABAYASHI, Shiga (JP); Hiromichi UMEMURA, Shiga (JP)

(21) Appl. No.: 16/955,236

(22) PCT Filed: Dec. 14, 2018
(86) PCT No.: PCT/JP2018/046174

§ 371 Date: Jun. 18, 2020

(30) Foreign Application Priority Data
Dec. 20, 2017 (JP) 2017-244008

(51) Int. Cl. C03B 25/12; C03B 17/06; C03B 5/027; C03B 33/02

(52) U.S. Cl. CPC C03B 25/12; C03B 17/064; C03B 2201/07; C03B 33/02; C03B 5/027

(57) ABSTRACT

A method of manufacturing a glass sheet stably reduces a variation in a thermal shrinkage rate to 15 ppm or less. The method includes a melting step of melting, in an electric melting furnace, a glass batch prepared so as to give glass comprising 3 mass % or less of B₂O₃, a forming step of forming a molten glass into a sheet-shaped glass, an annealing step of annealing the sheet-shaped glass in an annealing furnace, and a cutting step of cutting the annealed sheet-shaped glass into predetermined dimensions, to thereby obtain a glass sheet having a β-OH value of less than 0.2/mm and a thermal shrinkage rate of 15 ppm or less. The method includes measuring a thermal shrinkage rate of the glass sheet and adjusting a cooling rate of the sheet-shaped glass in the annealing step depending on variation in thermal shrinkage rate with respect to a target value.

### TECHNICAL FIELD

The present invention relates to a method of manufacturing a glass sheet capable of stably manufacturing a glass sheet having a low thermal shrinkage rate.

### BACKGROUND ART

In general, a gas combustion furnace utilizing gas combustion is widely utilized as a glass melting furnace for melting glass raw materials.

In the glass melting furnace utilizing gas combustion, gas combustion is always performed in the furnace. Therefore, a water concentration in molten glass is substantially dominated by a water content in an exhaust gas generated by burner combustion, and is kept at a relatively high level. As a result, glass to be manufactured is increased in water content (β-OH value) and reduced in strain point, and a glass sheet is increased in thermal shrinkage rate serving as an indicator of thermal dimensional stability. In the case of a glass substrate for a display, such as a low-temperature polysilicon TFT or an OLED, heat treatment at high temperature is performed. When a glass sheet inferior in thermal dimensional stability is used, a display defect is liable to occur in a display device. Therefore, there is a demand for a glass sheet particularly having a low thermal shrinkage rate and small variation in thermal shrinkage rate.

In view of the above-mentioned circumstances, there is proposed that variation in thermal shrinkage rate of a glass sheet is reduced by controlling glass raw materials (see Patent Literatures 1 and 2). In addition, there is proposed that variation in thermal shrinkage rate of a glass sheet is reduced by reducing a pressure of an external space of an annealing furnace of a down-draw forming device with respect to a pressure of an internal space of the annealing furnace (Patent Literature 3).

### CITATION LIST

### Patent Literature

Patent Literature 1: JP 2014-88306 A

Patent Literature 2: JP 2017-530928 A

Patent Literature 3: JP 2013-126946 A

### SUMMARY OF INVENTION

### Technical Problem

In Patent Literature 1, the β-OH value of glass is adjusted by controlling the mixing ratio of the glass raw materials and cullet. In addition, in Patent Literature 2, the β-OH value of glass is adjusted by selecting glass batch materials.

In recent years, along with an increase in definition of a display screen, the glass substrate for a display, such as a low-temperature polysilicon TFT or an OLED, has been increasingly required to be reduced in thermal shrinkage rate, specifically to 15 ppm or less.

However, by the method in which the β-OH value of glass is adjusted by changing the mixing ratio of the glass raw materials and cullet or selecting glass batch materials as in Patent Literature 1 or 2, it is difficult to control the variation in thermal shrinkage rate of a glass sheet when the thermal shrinkage rate of the glass sheet is at such an extremely low level as 15 ppm or less. That is, when a target value of the thermal shrinkage rate of the glass sheet is at a level of about 20 ppm, the β-OH value of glass can be adjusted by changing the glass raw materials or the cullet. However, in order to reduce the thermal shrinkage rate of the glass sheet to 15 ppm or less, it is required that water contents in the glass raw materials be reduced to near the limits. Therefore, even when the thermal shrinkage rate of the glass sheet exceeds 15 ppm owing to changes in glass melting conditions or the like, it is difficult to adopt measures to further reduce the β-OH value of glass by changing the glass raw materials, and it is thus difficult to reduce the thermal shrinkage rate of the glass sheet.

In addition, in Patent Literature 3, variation in thermal shrinkage rate of a glass sheet in a width direction is reduced by reducing variation in temperature in an inside of the annealing furnace of the down-draw device. It is not intended that variation in thermal shrinkage rate between glass sheets produced at different timings caused by changes in β-OH value of glass is reduced. In addition, it is not assumed that the thermal shrinkage rate is reduced to 15 ppm or less by reducing the β-OH value of glass.

A technical object of the present invention is to provide a method of manufacturing a glass sheet capable of, while achieving a thermal shrinkage rate of 15 ppm or less, stably reducing variation in thermal shrinkage rate.

### Solution to Problem

According to one embodiment of the present invention, which has been devised to achieve the above-mentioned object, there is provided a method of manufacturing a glass sheet, comprising: a melting step of melting, in an electric melting furnace, a glass batch prepared so as to give glass comprising 3 mass % or less of B₂O₃; a forming step of forming molten glass into a sheet-shaped glass; an annealing step of annealing the sheet-shaped glass in an annealing furnace; and a cutting step of cutting the annealed sheet-shaped glass into predetermined dimensions, to thereby obtain a glass sheet having a β-OH value of less than 0.2/mm and a thermal shrinkage rate of 15 ppm or less, the method comprising measuring a thermal shrinkage rate of the glass sheet and adjusting a cooling rate of the sheet-shaped glass in the annealing step depending on variation in thermal shrinkage rate with respect to a target value. The “glass batch” as used herein is a collective term for glass raw materials and cullet obtained by finely pulverizing a glass article.

In the method according to the one embodiment of the present invention, the glass batch prepared so as to give glass comprising 3 mass % or less of B₂O₃ is melted in the electric melting furnace, and hence the glass sheet having a β-OH value of the glass of less than 0.2/mm and a thermal shrinkage rate of 15 ppm or less is easily obtained.

Specifically, the β-OH value of the glass is easily affected by water contained in the glass batch to be loaded into a glass melting furnace. In particular, a glass raw material serving as a boron source has a moisture absorbing property and may contain water of crystallization, and hence is liable to take water into the glass. Therefore, as the content of B₂O₃ in the glass is reduced more, the β-OH value of the glass is reduced more, and the thermal shrinkage rate of the glass sheet is reduced more easily. Further, when the glass is melted through use of the electric melting furnace, an increase in water content in an atmosphere resulting from, for example, gas combustion in the melting furnace is suppressed, and hence the water content in the molten glass is easily reduced as compared to the case of using a gas combustion furnace. Thus, the glass manufactured through use of the electric melting furnace is reduced in β-OH value, and the glass sheet having a low thermal shrinkage rate is easily obtained. For the above-mentioned reasons, in the present invention, it is preferred that the glass be substantially free of B₂O₃. The “substantially free of B₂O₃” as used herein means that B₂O₃ is not intentionally included as a raw material, and mixing of B₂O₃ from impurities is not denied. Specifically, it is meant that the content of B₂O₃ is 0.1 mass % or less.

In general, the β-OH value of the glass changes and the thermal shrinkage rate of the glass sheet changes with changes in water content in the glass batch or glass melting conditions. However, in the present invention, the thermal shrinkage rate of the glass sheet is measured, and the cooling rate of the sheet-shaped glass in the annealing step is adjusted depending on variation in thermal shrinkage rate with respect to a target value. Specifically, when the variation in thermal shrinkage rate of the glass sheet with respect to a target value is large, the variation in thermal shrinkage rate of the glass sheet with respect to a target value is corrected by adjusting the annealing rate of the sheet-shaped glass in the annealing step. With this, the glass sheet having small variation in thermal shrinkage rate can be stably manufactured. It is preferred that the cooling rate be adjusted so that the variation in thermal shrinkage rate of the glass sheet with respect to a target value is ±1 ppm or less. The case in which “the variation in thermal shrinkage rate of the glass sheet with respect to a target value is ±1 ppm or less” means that, for example, when the target value of the thermal shrinkage rate of the glass sheet is 10 ppm, the thermal shrinkage rate is kept within the range of from 9 ppm to 11 ppm. In addition, the measurement of the thermal shrinkage rate of the glass sheet is not necessarily performed for all glass sheets to be produced, and spot check may be performed for part of the glass sheets.

In the present invention, the sheet-shaped glass is gradually cooled while being moved in the annealing step. In this case, the cooling rate is preferably from 300° C./min to 1,000° C./min in terms of an average cooling rate within the temperature range of from an annealing point to (annealing point−100° C.). The thermal shrinkage rate of the glass sheet changes depending on the cooling rate of the sheet-shaped glass at the time of annealing. Specifically, the glass sheet having been rapidly cooled has a high thermal shrinkage rate, and in contrast, the glass sheet having been slowly cooled has a low thermal shrinkage rate. Therefore, when the thermal shrinkage rate of the glass sheet is measured, and the thermal shrinkage rate is larger than the target value, it is appropriate to adjust the average cooling rate within the temperature range of from an annealing point to (annealing point−100° C.) so as to be reduced within the range of from 300° C./min to 1,000° C./min, and in contrast, when the thermal shrinkage rate is smaller than the target value, it is appropriate to adjust the average cooling rate within the temperature range of from an annealing point to (annealing point−100° C.) so as to be increased within the range of from 300° C./min to 1,000° C./min.

In the present invention, from the viewpoint of improving productivity, in the annealing step, an average cooling rate within the temperature range higher than the annealing point and an average cooling rate within the temperature range lower than the (annealing point−100° C.) may each be set to be higher than the average cooling rate within the temperature range of from an annealing point to (annealing point−100° C.). Specifically, those average cooling rates are each set to be preferably from 1.1 times to 20 times, more preferably from 1.5 times to 15 times as high as the average cooling rate within the temperature range of from an annealing point to (annealing point−100° C.).

In the present invention, the thermal shrinkage rate of the glass sheet is preferably 12 ppm or less, 10 ppm or less, 9 ppm or less, 8 ppm or less, 7 ppm or less, or 6 ppm or less, particularly preferably 5 ppm or less. However, when the thermal shrinkage rate of the glass sheet is to be reduced to 0 ppm, a significant reduction in productivity occurs, and hence the thermal shrinkage rate of the glass sheet is preferably 1 ppm or more or 2 ppm or more, particularly preferably 3 ppm or more. In addition, the variation in thermal shrinkage rate of the glass sheet with respect to a target value is preferably ±0.7 ppm or less, particularly preferably ±0.5 ppm or less. When the thermal shrinkage rate of the glass sheet is high, a display defect is liable to occur in a display device, such as a low-temperature polysilicon TFT or an OLED. In addition, when the variation in thermal shrinkage rate of the glass sheet is large, a display substrate cannot be stably produced.

A forming method in the present invention is not particularly limited, but a float method is preferred from the viewpoint that the annealing step can be prolonged, and a down-draw method, in particular, an overflow down-draw method is preferred from the viewpoint of improving the surface quality of the glass sheet or reducing the thickness thereof. In the overflow down-draw method, surfaces to serve as front and back surfaces of a glass substrate are formed in a state of free surfaces without being brought into contact with a forming body. As a result, a glass sheet having excellent surface quality (small surface roughness or waviness) can be manufactured at a low cost without polishing.

In the present invention, when the down-draw method is adopted, the length (difference in height) of the annealing furnace is preferably 3 m or more. While the annealing step is a step of removing strain from the glass sheet, as the length of the annealing furnace is longer, the cooling rate is adjusted more easily, and the thermal shrinkage rate of the glass sheet is reduced more easily. Therefore, the length of the annealing furnace is preferably 5 m or more, 6 m or more, 7 m or more, 8 m or more, or 9 m or more, particularly preferably 10 m or more.

In the present invention, the short side of the glass sheet is preferably 1,500 mm or more, and the long side thereof is preferably 1,850 mm or more. Specifically, as the dimensions of the glass sheet become larger, the number of glass substrates that can be produced from one glass sheet is increased more, and the production efficiency of the glass substrate is improved more, but the thermal shrinkage rate of the glass sheet is more liable to vary. However, by the method according to the one embodiment of the present invention, even when the glass sheet having large dimensions is manufactured, the variation in thermal shrinkage rate of the glass sheet can be reliably reduced, and the glass sheet having a low thermal shrinkage rate can be stably produced. The short side of the glass sheet is preferably 1,950 mm or more, 2,200 mm or more, or 2,800 mm or more, particularly preferably 2,950 mm or more, and the long side thereof is preferably 2,250 mm or more, 2,500 mm or more, or 3,000 mm, particularly preferably 3,400 mm or more.

In the present invention, the thickness of the glass sheet is preferably 0.7 mm or less, 0.6 mm or less, or 0.5 mm or less, particularly preferably 0.4 mm or less. With this, the weight saving of the glass sheet can be achieved, and the glass sheet is suitable for a mobile-type display substrate.

### Advantageous Effects of Invention

According to the present invention, the glass sheet having small variation in thermal shrinkage rate while achieving a thermal shrinkage rate of 15 ppm or less can be stably manufactured.

### BRIEF DESCRIPTION OF DRAWINGS

FIG. 1 is an explanatory view for illustrating a facility to be used for a method of manufacturing a glass sheet of the present invention.

FIG. 2 is an explanatory view for illustrating an overflow down-draw apparatus to be used for the method of manufacturing a glass sheet of the present invention.

FIG. 3 are explanatory views for illustrating a method of measuring the thermal shrinkage rate of a glass sheet.

### DESCRIPTION OF EMBODIMENTS

Now, embodiments of a method of manufacturing a glass sheet of the present invention are described with reference to the drawings.

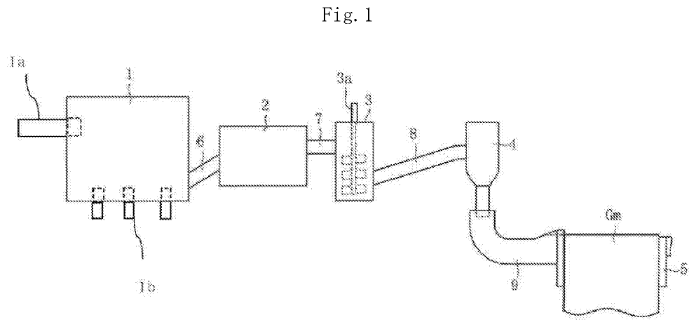

FIG. 1 is an explanatory view for illustrating a facility to be used for a method of manufacturing a glass sheet of the present invention, and the facility comprises, in order from an upstream side, an electric melting furnace 1, a fining bath 2, a homogenization bath (stirring bath) 3, a pot 4, and a forming body 5, and these components are connected to each other through transfer pipes 6 to 9.

The electric melting furnace 1 comprises a raw material supply device 1a configured to supply a glass batch obtained by blending glass raw materials and cullet. As the raw material supply device 1a, a screw feeder or a vibrating feeder may be used. The glass batch is successively supplied to a liquid surface of glass in the electric melting furnace 1. The electric melting furnace 1 has a structure in which a plurality of electrodes 1b each formed of molybdenum, platinum, tin, or the like are arranged, and when electricity is applied between these electrodes 1b, a current is applied through molten glass, and the glass is continuously melted by the Joule heat. Radiation heating with a heater or a burner may be supplementarily used in combination. However, water generated through burner combustion is taken into the molten glass, and it becomes difficult to reduce a water concentration in the molten glass, and hence, from the viewpoint of reducing the β-OH value of the glass, it is desired to perform all-electric melting with no use of a burner.

A molybdenum electrode is preferably used as the electrode 1b. The molybdenum electrode has a high degree of freedom for an arrangement position or an electrode shape. Therefore, even alkali-free glass, which is hard to conduct electricity, can be easily heated through application of a current by adopting optimum electrode arrangement and an optimum electrode shape. The electrode 1b preferably has a rod shape. When the electrode 1b has a rod shape, a desired number of electrodes 1b can be arranged at arbitrary positions on a side wall surface or a bottom wall surface of the electric melting furnace 1 while a desired electrode distance is kept. As a desired arrangement manner of the electrode 1b, a plurality of pairs of electrodes are arranged on a wall surface (e.g., a side wall surface or a bottom wall surface), in particular, a bottom wall surface of the electric melting furnace 1 at a short electrode distance.

The glass batch supplied from the raw material supply device 1a to the liquid surface of the glass in the electric melting furnace 1 is melted by the Joule heat to become molten glass. When the glass batch contains a chloride, the chloride is decomposed and volatilized to remove water in the glass to an atmosphere, to thereby reduce the β-OH value of the glass. In addition, a polyvalent oxide, such as a tin compound, contained in the glass batch is dissolved in the molten glass to act as a fining agent. For example, a tin component releases oxygen bubbles in the course of temperature increase. The oxygen bubbles having been released enlarge bubbles contained in a molten glass MG and cause the bubbles to float, to thereby remove the bubbles from the glass. In addition, the tin component absorbs the oxygen bubbles in the course of temperature reduction, to thereby eliminate the bubbles remaining in the glass.

As the glass batch to be supplied to the electric melting furnace 1, a blended material of glass raw materials may be used, and cullet may also be used in addition to the glass raw materials. When the cullet is used, as the use ratio of the cullet with respect to the total amount of the glass batch obtained by blending the glass raw materials and the cullet becomes larger, the meltability of the glass is improved more. Therefore, the use ratio of the cullet is preferably 1 mass % or more, 5 mass % or more, or 10 mass % or more, particularly preferably 20 mass % or more. An upper limit of the use ratio of the cullet is not particularly limited, but is preferably 50 mass % or less or 45 mass % or less, particularly preferably 40 mass % or less.

As the glass raw materials and the cullet, ones having a water content as low as possible are used. In addition, those materials may absorb water in the atmosphere during storage, and hence it is preferred to supply dry air to an inside of, for example, a raw material silo configured to weigh and supply the individual glass raw material, or a pre-furnace silo configured to supply the prepared glass batch to the melting furnace (not shown).

In the present invention, the water content of the glass batch is reduced to the extent possible and the glass is melted in the electric melting furnace 1, and thus the glass having a β-OH value of less than 0.2/mm can be manufactured. As the β-OH value of the glass becomes lower, the strain point of the glass becomes higher and a thermal shrinkage rate becomes lower. Therefore, the β-OH value is preferably 0.15/mm or less, 0.1/mm or less, or 0.07/mm or less, particularly preferably 0.05/mm or less.

The glass melted in the electric melting furnace 1 is subsequently transferred through the transfer pipe 6 to the fining bath 2. The molten glass is fined (subjected to bubble removal) by the action of a fining agent or the like in the fining bath 2. The fining bath 2 is not necessarily arranged, and a fining step for the glass may be performed on a downstream side of the electric melting furnace 1.

The molten glass thus fined is transferred through the transfer pipe 7 to the homogenization bath 3. The molten glass is stirred with a stirring blade 3a in the homogenization bath 3 to be homogenized.

The molten glass thus homogenized is transferred through the transfer pipe 8 to the pot 4. The molten glass is adjusted to a state (e.g., viscosity) suitable for forming in the pot 4.

The molten glass in the pot 4 is transferred through the transfer pipe 9 to the forming body 5. The forming body 5 of this embodiment is configured to form a molten glass Gm into a sheet shape by an overflow down-draw method to manufacture a glass sheet.

The forming body 5 is formed of refractory having a substantially wedge shape in a sectional shape, and has an overflow groove (not shown) formed on an upper portion thereof. After the molten glass Gm is supplied through the transfer pipe 9 to the overflow groove, the molten glass Gm is caused to overflow from the overflow groove to flow down along both side wall surfaces of the forming body 5. Moreover, the molten glasses Gm having flowed down are caused to join each other at lower end portions of the side wall surfaces to be down-drawn downwardly. With this, a sheet-shaped glass is formed.

The structure or material of the forming body 5 to be used in the overflow down-draw method is not particularly limited as long as desired dimensions or desired surface precision can be achieved. In addition, the transfer pipes 6 to 9 are each formed of, for example, a cylindrical tube formed of platinum or a platinum alloy, and are each configured to transfer the molten glass Gm in a lateral direction. The transfer pipes 6 to 9 are each heated through application of a current as required.

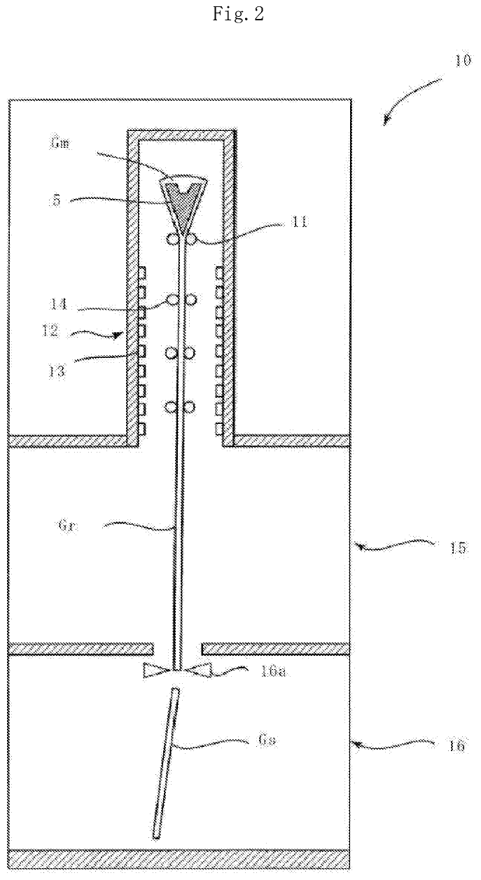

FIG. 2 is an explanatory view for illustrating an overflow down-draw apparatus 10 to be used for the method of manufacturing a glass sheet of the present invention. The forming body 5 has an overflow groove formed on an upper portion thereof as described above, and has an edge roller 11 arranged immediately below the forming body 5 and has a plurality of heaters 13 and tension rollers 14 arranged in an annealing furnace 12. The edge roller 11 and the tension rollers 14 are configured to rotate while holding both end portions of a sheet-shaped glass Gr, to thereby cool the sheet-shaped glass Gr while down-drawing the sheet-shaped glass Gr into a predetermined thickness. In addition, the plurality of heaters 13 in the annealing furnace 12 are arranged in a height direction and a width direction of an inner wall, and are capable of controlling the temperature of an atmosphere in the annealing furnace 12 section by section. A heater 13 arranged on a more downstream side is set to a lower temperature. That is, the temperatures of the heaters 13 are set so as to be gradually lower from an upstream side to a downstream side, and thus a temperature gradient is formed in the height direction of the annealing furnace 12, to thereby adjust the cooling rate of the sheet-shaped glass Gr. In addition, with the heaters 13, a temperature gradient can also be formed in the width direction of the annealing furnace 12. For example, the temperature of a heater located in a middle portion of the sheet-shaped glass may be set to be lower than the temperatures of heaters 13 located in both end portions of the sheet-shaped glass.

The rotation speeds of the tension rollers 14 may each be appropriately adjusted, and a method of applying a force in down-drawing the sheet-shaped glass Gr downwardly is not particularly limited. For example, there may be adopted a method of down-drawing the sheet-shaped glass Gr by using a tension roller comprising heat-resistant rolls to be brought into contact with the sheet-shaped glass Gr in the vicinity of both end portions, or a method of down-drawing the sheet-shaped glass Gr by, through division into a plurality of pairs, using a tension roller comprising a heat-resistant roll to be brought into contact with an end portion of the sheet-shaped glass Gr.

In the present invention, when the thermal shrinkage rate of the glass sheet is measured and the variation in thermal shrinkage rate with respect to a target value becomes large, the cooling rate of the sheet-shaped glass Gr may be appropriately adjusted by adjusting the temperatures of the heaters 13 or the rotation speeds of the tension rollers 14 in the annealing furnace 12. The temperature of the atmosphere in the annealing furnace 12 is liable to be disturbed by an updraft, and hence it is desired to control an inner pressure and an outer pressure of the furnace or arrange a mechanism configured to suppress entry of the updraft into the furnace so that the updraft is reduced to the extent possible.

The sheet-shaped glass Gr thus annealed is cooled in a cooling chamber 15. The cooling chamber 15 does not comprise a heater, and the sheet-shaped glass Gr is naturally cooled in the cooling chamber 16. The length (difference in height) of the cooling chamber 15 may be set to, for example, from about 2 m to about 10 m.

After the sheet-shaped glass Gr is subjected to a cooling step in the cooling chamber 15, the sheet-shaped glass Gr is cut into predetermined dimensions with a cutting device 16a in a cutting chamber 16 to become a glass sheet Gs. As the cutting device 16a, for example, a device having a scribing mechanism and a breaking mechanism is suitable.

In the present invention, the glass sheet is preferably an alkali-free glass sheet that comprises, in terms of mass %, 50% to 70% of SiO₂, 10% to 25% of Al₂O₃, 0% to 3% of B₂O₃, 0% to 10% of MgO, 0% to 15% of CaO, 0% to 10% of SrO, 0% to 15% of BaO, 0% to 5% of ZnO, 0% to 5% of ZrO₂, 0% to 5% TiO₂, 0% to 10% of P₂O₅, and 0% to 0.5% of SnO₂ and is substantially free of an alkalimetaloxide. The reasons why the contents of the components are restricted as described above are described below. In the descriptions of the components, the expression “%” refers to “mass %” unless otherwise specified.

SiO₂ is a component that forms a skeleton of glass. The content of SiO₂ is preferably 50% or more, 55% or more, or 58% or more, particularly preferably 60% or more. In addition, the content of SiO₂ is preferably 70% or less, 66% or less, 64% or less, or 63% or less, particularly preferably 62% or less. When the content of SiO₂ is small, a density is excessively increased, and acid resistance is liable to be reduced. Meanwhile, when the content of SiO₂ is large, a viscosity at high temperature is increased and thus meltability is liable to be reduced. Besides, a devitrified crystal, such as cristobalite, is liable to be precipitated, resulting in an increase in liquidus temperature.

Al₂O₃ is also a component that forms the skeleton of the glass. In addition, Al₂O₃ is a component that increases a strain point and a Young's modulus, and suppresses phase separation. The content of Al₂O₃ is preferably 10% or more, 12% or more, 13% or more, 14% or more, 15% or more, 16% or more, 17% or more, or 18% or more, particularly preferably 19% or more. In addition, the content of Al₂O₃ is preferably 25% or less, 24% or less, 23% or less, or 22% or less, particularly preferably 20% or less. When the content of Al₂O₃ is small, the strain point and the Young's modulus are liable to be reduced. In addition, the glass is liable to undergo phase separation. Meanwhile, when the content of Al₂O₃ is large, a devitrified crystal, such as mullite or anorthite, is liable to be precipitated, resulting in an increase in liquidus temperature.

B₂O₃ is a component that increases the meltability and devitrification resistance. However, when the content of B₂O₃ is large, the amount of water taken thereinto from glass raw materials is increased, and the strain point and the Young's modulus are liable to be reduced. The content of B₂O₃ is preferably 3% or less, less than 3%, 2.5% or less, 2% or less, 1.9% or less, 1.6% or less, 1.5% or less, 1% or less, 0.8% or less, or 0.5% or less. It is particularly preferred that the glass be substantially free of B₂O₃. However, when priority is given to improvement in meltability of the glass, B₂O₃ is incorporated at a content of preferably 0.1% or more or 0.2% or more, more preferably 0.3% or more.

MgO is a component that reduces the viscosity at high temperature and thus increases the meltability. Among alkaline earth metal oxides, MgO is a component that remarkably increases the Young's modulus. The content of MgO is preferably 10% or less, 9% or less, 8% or less, 6% or less, 5% or less, 4% or less, or 3.5% or less, particularly preferably 3% or less. In addition, the content of MgO is preferably 1% or more or 1.5% or more, particularly preferably 2% or more. When the content of MgO is small, the meltability or the Young's modulus is liable to be reduced. Meanwhile, when the content of MgO is large, the devitrification resistance or the strain point is liable to be reduced.

CaO is a component that reduces the viscosity at high temperature and thus remarkably increases the meltability without reducing the strain point. In addition, among the alkaline earth metal oxides, CaO is a component that reduces a raw material cost because an introduction raw material thereof is relatively inexpensive. The content of CaO is preferably 15% or less, 12% or less, 11% or less, 8% or less, or 6% or less, particularly preferably 5% or less. In addition, the content of CaO is preferably 1% or more, 2% or more, or 3% or more, particularly preferably 4% or more. When the content of CaO is small, it becomes difficult to exhibit the above-mentioned effects. Meanwhile, when the content of CaO is too large, the glass is liable to be devitrified, and a thermal expansion coefficient is liable to be increased.

SrO is a component that suppresses phase separation of the glass, and increases the devitrification resistance. Further, SrO is also a component that reduces the viscosity at high temperature and thus increases the meltability without reducing the strain point, and suppresses an increase in liquidus temperature. The content of SrO is preferably 10% or less, 7% or less, 5% or less, or 3.5% or less, particularly preferably 3% or less. In addition, the content of SrO is preferably 0.1% or more, 0.2% or more, 0.3% or more, 0.5% or more, or 1.0% or more, particularly preferably 1.5% or more. When the content of SrO is small, it becomes difficult to exhibit the above-mentioned effects. Meanwhile, when the content of SrO is large, a strontium silicate-based devitrified crystal is liable to be precipitated, resulting in a reduction in devitrification resistance.

BaO is a component that remarkably increases the devitrification resistance. The content of BaO is preferably 15% or less, 14% or less, 13% or less, 12% or less, 11% or less, 10.5% or less, 10% or less, or 9.5% or less, particularly preferably 9% or less. In addition, the content of BaO is preferably 1% or more, 3% or more, 4% or more, 5% or more, 6% or more, or 7% or more, particularly preferably 8% or more. When the content of BaO is small, it becomes difficult to exhibit the above-mentioned effects. Meanwhile, when the content of BaO is large, the density is excessively increased, and the meltability is liable to be reduced. In addition, a devitrified crystal containing BaO is liable to be precipitated, resulting in an increase in liquidus temperature.

ZnO is a component that increases the meltability. However, when the content of ZnO is large, the glass is liable to be devitrified, and the strain point is liable to be reduced. The content of ZnO is preferably from 0% to 5%, from 0% to 4%, from 0% to 3%, from 0% to 2%, or from 0% to 1%, particularly preferably from 0% to 0.5%.

ZrO₂ is a component that increases chemical durability. However, when the content of ZrO₂ is large, devitrified stones of ZrSiO₄ are liable to be generated. The content of ZrO₂ is preferably from 0% to 5%, from 0% to 4%, from 0% to 3%, or from 0.1% to 2%, particularly preferably from 0.1% to 0.5%.

TiO₂ is a component that reduces the viscosity at high temperature and thus increases the meltability, and suppresses solarisation. However, when the content of TiO₂ is large, a transmittance is liable to be reduced owing to coloration of the glass. The content of TiO₂ is preferably from 0% to 5%, from 0% to 4%, from 0% to 3%, or from 0% to 2%, particularly preferably from 0% to 0.1%.

P₂O₅ is a component that increases the strain point, and suppresses precipitation of an alkaline earth aluminosilicate-based devitrified crystal, such as anorthite. However, when the content of P₂O₅ is large, the glass is liable to undergo phase separation. The content of P₂O₅ is preferably from 0% to 10%, from 0% to 9%, from 0% to 8%, from 0% to 7%, or from 0% to 6%, particularly preferably from 0% to 5%.

SnO₂ has a satisfactory fining action in a high temperature region, and is a component that increases the strain point, and reduces the viscosity at high temperature. In addition, SnO₂ is advantageous in that, in the case of an electric melting furnace using a molybdenum electrode, the electrode is not corroded. The content of SnO₂ is preferably from 0% to 0.5%, from 0.001% to 0.5%, from 0.001% to 0.45%, from 0.001% to 0.4%, from 0.01% to 0.35%, or from 0.1% to 0.3%, particularly preferably from 0.15% to 0.3%. When the content of SnO₂ is large, a devitrified crystal of SnO₂ is liable to be precipitated. In addition, a devitrified crystal of ZrO₂ is liable to be precipitated acceleratedly. When the content of SnO₂ is less than 0.001%, it becomes difficult to exhibit the above-mentioned effects.

In the present invention, in addition to the above-mentioned components, Cl, F, SO₃, C, CeO₂, or metal powder, such as Al or Si, may be incorporated up to 3% in terms of a total content. It is desired that the glass be substantially free of As₂O₃ and Sb₂O₃ from an environmental viewpoint or the viewpoint of preventing corrosion of an electrode.

In the present invention, the “substantially free of an alkali metal oxide” means that Li₂O, Na₂O, and K₂O are not intentionally included as raw materials, and specifically means that the content of the alkali metal oxide is 0.2% or less.

The alkali-free glass obtained by the method of the present invention has a strain point of preferably 710° C. or more, 720° C. or more, 730° C. or more, or 740° C., particularly preferably 750° C. or more. As the strain point is to be increased more, the temperature at the time of melting or forming is increased more, and the manufacturing cost of the glass sheet is increased more. Therefore, the strain point is preferably 800° C. or less.

The alkali-free glass obtained by the method of the present invention has a temperature corresponding to 10⁴ dPa·s of preferably 1,380° C. or less or 1,370° C. or less, particularly preferably 1,360° C. or less. When the temperature corresponding to 10⁴ dPa·s is increased, the temperature at the time of forming is excessively increased, and thus a manufacturing yield is liable to be reduced.

The alkali-free glass obtained by the method of the present invention has a temperature corresponding to 10^{2.5} dPa·s of preferably 1,670° C. or less or 1,660° C. or less, particularly preferably 1,650° C. or less. When the temperature corresponding to 10^{2.5} dPa·s is increased, it becomes hard to melt the glass, and thus a defect, such as bubbles, is liable to be increased, or the manufacturing yield is liable to be reduced.

The alkali-free glass obtained by the method of the present invention has an annealing point of preferably 750° C. or more, 780° C. or more, 800° C. or more, or 810° C. or more, particularly preferably 820° C. or more.

The alkali-free glass obtained by the method of the present invention has a liquidus temperature of preferably less than 1,250° C., less than 1,240° C., or less than 1,230° C., particularly preferably less than 1,220° C. With this, a devitrified crystal is less liable to be generated during manufacturing of the glass. In addition, the glass is easily formed by an overflow down-draw method, and hence the surface quality of the glass sheet is improved, and a reduction in manufacturing yield can be suppressed. Herein, from the viewpoint of an increase in size of a glass substrate or an increase in definition of a display of recent years, it is of great significance to increase the devitrification resistance also in order to suppress a devitrified product, which may form a surface defect, to the extent possible.

The alkali-free glass obtained by the method of the present invention has a viscosity at a liquidus temperature of preferably 10^{4.9} dPa·s or more, 10^{5.1} dPa·s or more, or 10^{5.2} dPa·s or more, particularly preferably 10^{5.3} dPa·s or more. With this, devitrification is less liable to occur at the time of forming, and hence the glass sheet is easily formed by an overflow down-draw method, and the surface quality of the glass sheet can be improved. The “viscosity at a liquidus temperature” is an indicator of the formability, and as the viscosity at a liquidus temperature becomes higher, the formability is improved more.

### EXAMPLES

### Example 1

The glass of Examples (Sample Nos. 1 to 9) that can be used in the present invention is shown in Tables 1 and 2.

TABLE 1

| Sample No. | | 1 | 2 | 3 | 4 | 5 |
|---|---|---|---|---|---|---|
| Glass | SiO₂ | 63.4 | 63.4 | 63.4 | 63.4 | 61.5 |
| composition | Al₂O₃ | 15.9 | 15.9 | 15.9 | 15.9 | 17.9 |
| (mass %) | B₂O₃ | — | — | — | — | 1.0 |
| | MgO | — | 2.0 | — | 2.0 | 3.7 |
| | CaO | 9.4 | 7.4 | 11.4 | 10.4 | 3.8 |
| | SrO | 2.0 | 2.0 | 2.0 | 2.0 | 5.9 |
| | BaO | 9.0 | 9.0 | 7.0 | 6.0 | 5.9 |
| | SnO₂ | 0.3 | 0.3 | 0.3 | 0.3 | 0.3 |

| | | | | | |
|---|---|---|---|---|---|
| Density (g/cm³) | 2.646 | 2.644 | 2.634 | 2.629 | 2.631 |
| Young's modulus (GPa) | 82.1 | 80.4 | 81.4 | 82.9 | 83.0 |
| Strain point (° C.) | 755 | 740 | 750 | 735 | 735 |
| Annealing point (° C.) | 810 | 800 | 800 | 790 | 785 |
| 10⁴ dPa · s (° C.) | 1,365 | 1,365 | 1,335 | 1,315 | 1,340 |
| 10^{2.5} dPa · s (° C.) | 1,655 | 1,640 | 1,610 | 1,585 | 1,605 |
| TL (° C.) | 1,215 | 1,220 | 1,215 | 1,215 | 1,230 |
| Log₁₀ηTL (dPa · s) | 5.3 | 5.2 | 5.0 | 4.9 | 4.9 |

TABLE 2

| Sample No. | | 6 | 7 | 8 | 9 |
|---|---|---|---|---|---|
| Glass | SiO₂ | 61.5 | 62.5 | 61.1 | 61.2 |
| composition | Al₂O₃ | 15.8 | 16.2 | 18.6 | 20.1 |
| (mass %) | B₂O₃ | — | 0.5 | 0.7 | 1.6 |
| | MgO | — | 2.0 | 3.2 | 2.5 |
| | CaO | 9.5 | 7.8 | 5.1 | 4.6 |
| | SrO | 0.5 | 0.5 | 0.6 | 1.8 |
| | BaO | 12.4 | 10.2 | 10.5 | 8.0 |
| | SnO₂ | 0.3 | 0.3 | 0.2 | 0.2 |

| | | | | |
|---|---|---|---|---|
| Density (g/cm³) | 2.695 | 2.648 | 2.640 | 2.640 |
| Young's modulus (GPa) | 80.3 | 81.8 | 83.1 | 83.1 |
| Strain point (° C.) | 745 | 735 | 749 | 747 |
| Annealing point (° C.) | 800 | 790 | 800 | 790 |
| 10⁴ dPa · s (° C.) | 1,345 | 1,345 | 1,362 | 1,365 |
| 10^{2.5} dPa · s (° C.) | 1,625 | 1,620 | 1,633 | 1,633 |
| TL (° C.) | 1,185 | 1,210 | 1,218 | 1,227 |
| Log₁₀ηTL (dPa · s) | 5.4 | 5.2 | 5.3 | 5.2 |

The glass samples shown in Tables 1 and 2 were each produced as described below. First, a glass batch obtained by blending glass raw materials so as to give the composition shown in the table was loaded into a platinum crucible, and was then melted at 1,600° C. to 1,650° C. for 24 hours. When the glass batch was melted, the glass batch was stirred with a platinum stirrer to be homogenized. Next, the resultant molten glass was poured out on a carbon sheet to be formed into a sheet shape, and was then annealed at a temperature around an annealing point for 30 minutes. The sample thus obtained was measured for a density, a Young's modulus, a strain point, an annealing point, a temperature corresponding to 10⁴ dPa·s, a temperature corresponding to 10^{2.5} dPa·s, a liquidus temperature TL, and a viscosity Log₁₀ ηTL at a liquidus temperature.

The density was measured by a well-known Archimedes method.

The Young's modulus was measured by a flexural resonance method.

The strain point and the annealing point were each measured by a method specified in ASTM C336.

The temperature corresponding to a viscosity at high temperature of 10⁴ dPa·s and the temperature corresponding to a viscosity at high temperature of 10^{2.5} dPa·s were each measured by a platinum sphere pull up method.

The liquidus temperature TL was measured as described below. Glass powder which had passed through a standard 30-mesh sieve (500 μm) and remained on a 50-mesh sieve (300 μm) was loaded into a platinum boat, and the platinum boat was kept for 24 hours in a gradient heating furnace set to from 1,100° C. to 1,350° C. and was then taken out of the gradient heating furnace. At this time, a temperature at which devitrification (crystalline foreign matter) was observed in glass was measured.

The viscosity Log₁₀ ηTL at a liquidus temperature was measured as the viscosity of the glass at the liquidus temperature by a platinum sphere pull up method.

As apparent from the tables, the glass of each of Sample Nos. 1 to 9 has a strain point of 735° C. or more and an annealing point of 785° C. or more, and hence easily achieves a reduction in thermal shrinkage rate. In addition, the glass of each of Sample Nos. 1 to 9 has a liquidus temperature of 1,230° C. or less and a viscosity at a liquidus temperature of 10^{4.9} dPa·s or more, and hence is less liable to be devitrified at the time of forming. In particular, the glass of each of Sample Nos. 1, 2, and 6 to 9 has a viscosity at a liquidus temperature of 10^{5.2} dPa·s or more, and hence is easily formed by an overflow down-draw method.

### Example 2

A glass batch was prepared so as to give the glass of Sample No. 6 shown in Table 1. Next, the glass batch was loaded into an electric melting furnace and melted at 1,650° C. Next, the resultant molten glass was fined and homogenized in a fining bath and a homogenization bath, and was then adjusted to a viscosity suitable for forming in a pot. Next, the molten glass was formed into a sheet shape with an overflow down-draw apparatus and annealed in an annealing furnace. After that, the resultant sheet-shaped glass was cut to produce a glass sheet having dimensions measuring 1,500 mm by 1,850 mm by 0.7 mm.

In the overflow down-draw apparatus, the length of the annealing furnace was set to 5 m, and the sheet drawing speed of the sheet-shaped glass was set to 350 cm/min while the temperatures of a plurality of heaters arranged to an inner wall of the annealing furnace were appropriately adjusted, to thereby set an average cooling rate within the temperature range of from an annealing point to (annealing point−100° C.) to 385° C./min. The glass sheet thus obtained had a β-OH value of 0.1/mm and a thermal shrinkage rate of 10 ppm.

Next, a glass sheet was produced by changing the glass melting conditions (temperature, time, and the like) without changing the sheet drawing speed and the average cooling rate. As a result, the glass sheet had a β-OH value of 0.18/mm and a thermal shrinkage rate of more than 11 ppm, but the thermal shrinkage rate was able to be returned to 10 ppm by changing the sheet drawing speed to 250 cm/min and the average cooling rate within the temperature range of from an annealing point to (annealing point−100° C.) to 275° C./min.

In the present invention, the “sheet drawing speed” refers to a speed at which a center portion in a sheet width direction of the sheet-shaped glass, which is continuously formed, passes through an annealing region. In this Example, the sheet drawing speed was measured by causing a roller for measurement to abut against the center portion in the sheet width direction at a middle point (a position corresponding to a temperature of an annealing point−50° C.) of the annealing region. In addition, the “average cooling rate” refers to a rate obtained by calculating a time for which the sheet-shaped glass passes through a region (annealing region) corresponding to the temperature range of from an annealing point to (annealing point−100° C.), and dividing a difference in temperature of the center portion or an end portion in the annealing region by the pass time.

In addition, the β-OH value of the glass was determined by measuring the transmittance of the glass by FT-IR and using the following equation.

β-OH value=(1/X)log(T1/T2)

X: Glass wall thickness (mm)
T1: Transmittance (%) at a reference wavelength of 3,846 cm⁻¹
T2: Minimum transmittance (%) around a hydroxyl group absorption wavelength of 3,600 cm⁻¹

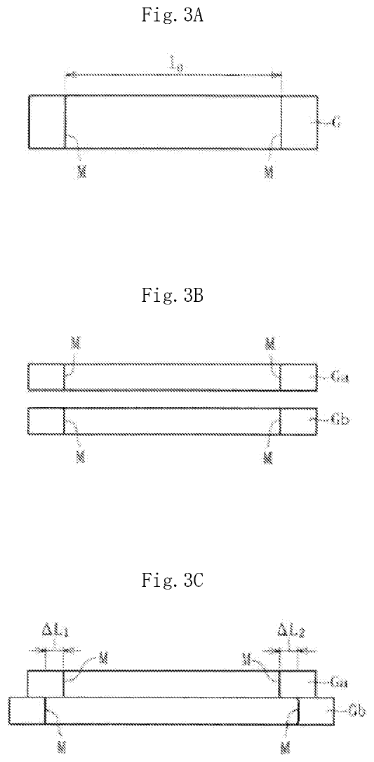

In addition, the thermal shrinkage rate of the glass sheet was measured by the following method. First, as illustrated in FIG. 3(a), a strip-shaped sample G measuring 160 mm by 30 mm was prepared as a sample of the glass sheet. The strip-shaped sample G was marked with marks M on both end portions in a long side direction at positions spaced apart from end edges by from 20 mm to 40 mm through use of waterproof abrasive paper #1000. After that, as illustrated in FIG. 3(b), the strip-shaped sample G having formed thereon the marks M was divided in two along a direction perpendicular to the marks M, to thereby produce sample pieces Ga and Gb. Moreover, only one glass piece Gb was subjected to heat treatment in which the temperature was increased from normal temperature up to 500° C. at 5° C./min, kept at 500° C. for 1 hour, and then reduced at 5° C./min. After the heat treatment, as illustrated in FIG. 3(c), under the state in which the sample piece Ga not having been subjected to the heat treatment and the sample piece Gb having been subjected to the heat treatment were arranged next to each other, positional shift amounts (ΔL1 and ΔL2) between the marks M of the two sample pieces Ga and Gb were read with a laser microscope, and the thermal shrinkage rate was calculated by the following equation. In the equation, l₀ represents the distance between the initial marks M.

Thermal shrinkage rate (ppm)=[{ΔL1 (μm)+ΔL2 (μm)}×10³]/l₀ (mm)

From the results of Example 2, it can be understood that, even when the thermal shrinkage rate of the glass sheet is 15 ppm or less and the variation in thermal shrinkage rate with respect to a target value becomes large, the thermal shrinkage rate of the glass sheet can be corrected by adjusting the cooling rate of the sheet-shaped glass in the annealing step without adjusting the β-OH value of the glass.

### REFERENCE SIGNS LIST

1 electric melting furnace
1a raw material supply device
1b electrode
2 fining bath
3 homogenization bath (stirring bath)
3a stirring blade
4 pot
5 forming body
6 to 9 transfer pipe
10 overflow down-draw apparatus
11 edge roller
12 annealing furnace
13 heater
14 tension roller
15 cooling chamber
16 cutting chamber
16a cutting device
Gm molten glass
Gr sheet-shaped glass
Gs glass sheet

1. A method of manufacturing a glass sheet, comprising:
a melting step of melting, in an electric melting furnace, a glass batch prepared so as to give glass comprising 3 mass % or less of B₂O₃;
a forming step of forming molten glass into a sheet-shaped glass;
an annealing step of annealing the sheet-shaped glass in an annealing furnace; and
a cutting step of cutting the annealed sheet-shaped glass into predetermined dimensions, to thereby obtain a glass sheet having a β-OH value of less than 0.2/mm and a thermal shrinkage rate of 15 ppm or less,
the method comprising measuring a thermal shrinkage rate of the glass sheet and adjusting a cooling rate of the sheet-shaped glass in the annealing step depending on variation in thermal shrinkage rate with respect to a target value.

2. The method of manufacturing a glass sheet according to claim 1, wherein the glass is substantially free of B₂O₃.

3. The method of manufacturing a glass sheet according to claim 1, wherein the adjusting a cooling rate of the sheet-shaped glass in the annealing step is performed so that the variation in thermal shrinkage rate with respect to a target value is ±1 ppm or less.

4. The method of manufacturing a glass sheet according to claim 1, wherein the cooling rate of the sheet-shaped glass is from 300° C./min to 1,000° C./min in terms of an average cooling rate within a temperature range of from an annealing point to (annealing point−100° C.).

5. The method of manufacturing a glass sheet according to claim 1,
wherein the forming step comprises performing down-draw forming, and
wherein the annealing furnace has a length of 3 m or more.

6. The method of manufacturing a glass sheet according to claim 1, wherein the glass sheet has dimensions measuring 1,500 mm or more in a short side and 1,850 mm or more in a long side.

7. The method of manufacturing a glass sheet according to claim 1, wherein the glass sheet has a thickness of 0.7 mm or less.

8. The method of manufacturing a glass sheet according to claim 2, wherein the adjusting a cooling rate of the sheet-shaped glass in the annealing step is performed so that the variation in thermal shrinkage rate with respect to a target value is ±1 ppm or less.
